(19) United States
(12) Patent Application Publication
(10) Pub. No.: US 2020/0210116 A1
(43) Pub. Date: Jul. 2, 2020

(54) SYSTEM AND METHOD FOR CONFIGURING PRINT SETTING COMBINATIONS BETWEEN MOBILE DEVICES AND MULTI-FUNCTION PRINTERS

(71) Applicant: Konica Minolta Laboratory U.S.A., Inc., San Mateo, CA (US)

(72) Inventor: Shohei IWAMOTO, San Mateo, CA (US)

(73) Assignee: Konica Minolta Laboratory U.S.A., Inc., San Mateo, CA (US)

(21) Appl. No.: 16/234,121

(22) Filed: Dec. 27, 2018

(51) Int. Cl. G06F 3/12

(52) U.S. Cl. CPC G06F 3/1205; G06F 3/1297; G06F 3/1258; G06F 3/1292

(57) ABSTRACT

A system and method are disclosed for mobile printing. The system including a mobile device, the mobile device including a non-transitory memory configured to store a mobile printing application for the mobile device, the mobile printing application configured to support a limited number of features of an image forming apparatus; a user interface of the mobile printing application; and wherein the mobile device is configured to send print settings to the image forming apparatus; and the image forming apparatus including: a processor configured to receive the print settings; a memory configured to store the print settings; a user interface; wherein the image forming apparatus is configured to accept modifications to the print settings through the user interface of the image forming apparatus and to make modified print settings; and wherein the image forming apparatus is configured to execute a print job using the modified print settings.

### FIELD OF THE INVENTION

The present disclosure generally relates to a system and method for providing printing configurations supported by printers and multi-function printers (MFPs) in a mobile printing application.

### BACKGROUND OF THE INVENTION

Multi-Function Printers (MFP) have several printing features which can be applied to a print job, and which the user can configure those features and send a print job to a printer using a mobile printing application. However, users cannot configure a print job with all of the features on a printer or MFP since most mobile printing applications do not support or have those feature configurations available in the mobile printing application.

Most mobile printing applications cannot provide full configurations or features support by a printer or MFP because modification of the printing document in the mobile printing application can be required to apply some configuration features. For example, modifying the printing document can require relatively high computer processing unit (CPU) performance and a relatively large memory size, which most mobile devices do not have. In addition, providing full configuration for mobile devices can be difficult due to limitations in screen size.

Pull printing is a printing feature where a user's print job is held on a server (server-based pull printing) or on a user's workstation (server-less pull printing) and released by the user at any printing device that supports the pull printing feature. In pull printing, the print job is created in advance.

### SUMMARY OF THE INVENTION

In consideration of the above issues, it would be desirable to have a system and method that provides full printing configuration settings of a printer or MFP to mobile users through a mobile printing application and wherein the mobile printing application does not create the print job in advance, which provides the user with the flexibility to apply user preferred printer settings to print data from a mobile device and mobile printing application.

A system is disclosed comprising: a mobile device, the mobile device comprising: a processor configured to execute software stored in memory; a non-transitory memory configured to store a mobile printing application for the mobile device, the mobile printing application configured to support a limited number of features of an image forming apparatus; a user interface of the mobile printing application; and wherein the mobile device is configured to send print settings to the image forming apparatus; and the image forming apparatus comprising: a processor configured to receive the print settings; a non-transitory memory configured to store the print settings; a user interface of the image forming apparatus; wherein the image forming apparatus is configured to accept modifications to the print settings through the user interface of the image forming apparatus and to make modified print settings; and wherein the image forming apparatus is configured to execute a print job using the modified print settings.

A method is disclosed for configuring print jobs on a mobile device, the method comprising: hosting a mobile printing application on the mobile device, the mobile printing application configured to support a limited number of features of an image forming apparatus; sending a print job to the image forming apparatus for printing; modifying the print job on the image forming apparatus to include one or more features that are not supported by the mobile printing application; and printing the modified print job on the image forming apparatus.

A non-transitory computer readable medium storing computer readable program code executed by a processor for configuring print jobs on a mobile device is disclosed, the process comprising: hosting a mobile printing application on the mobile device, the mobile printing application configured to support a limited number of features of an image forming apparatus; sending a print job to the image forming apparatus for printing; modifying the print job on the image forming apparatus to include one or more features that are not supported by the mobile printing application; and printing the modified print job on the image forming apparatus.

It is to be understood that both the foregoing general description and the following detailed description are exemplary and explanatory and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is an illustration of an exemplary print system for printing from a mobile device in accordance with an exemplary embodiment.

FIG. 2 is an illustration of a mobile device in accordance with an exemplary embodiment.

FIG. 3 is an illustration of a computing device in accordance with an exemplary embodiment.

FIG. 4 is an illustration of a printer or image forming apparatus in accordance with an exemplary embodiment.

FIG. 5 is an illustration of an exemplary printer driver user interface of a mobile printing application in accordance with an exemplary embodiment.

FIG. 6 is an illustration of a flow chart illustrating a mobile printing application with a printing configuration in accordance with an exemplary embodiment.

FIG. 7 is an illustration of exemplary printer driver user interface of a mobile printing application in accordance with another exemplary embodiment.

FIG. 8 is an illustration of a flow chart illustrating a mobile printing application with a printing configuration in accordance with another exemplary embodiment.

### DETAILED DESCRIPTION

Reference will now be made in detail to the present preferred embodiments of the invention, examples of which are illustrated in the accompanying drawings. Wherever possible, the same reference numbers are used in the drawings and the description to refer to the same or like parts.

The present disclosure provides users with configurations and corresponding features with relatively easy processing even though a mobile printing application on a mobile device does not support the configurations and corresponding features. In accordance with an exemplary embodiment, it would be desirable to have a mobile printing application that can print a document from a mobile device on an image forming apparatus or printer with printing configurations (i.e., full printing configurations) that are not available in most mobile printing applications. In accordance with an exemplary embodiment, the mobile printing application provides users with the configurations to apply the user preferred settings to the printing of a document from a mobile device.

In accordance with an exemplary embodiment, the mobile printing application can be configured to connect to the printer and synchronizes the user control of the printer with the mobile printing application. In accordance with an exemplary embodiment, the user can configure the printing options and apply the printing settings to the print job by using the printer control panel when starting the printing of the print job. When the user starts the print job, the mobile printing application sends the printing data to the printer. After the printer receives the printing data, the printer applies the selected printing options to the print job.

In accordance with an exemplary embodiment, the user can print with full printing features supported by a printer even though the mobile printing application on the user's mobile device does not provide those configurations. In addition, the user can configure the provided features with a larger screen than provided on the user interface of the mobile device.

For example, in accordance with an exemplary embodiment, the user can modify the applying features to a print job by temporally storing the print job on the image forming apparatus. Accordingly, the present disclosure provides a method and system for users to avail a print job with full configuration features with relatively easy processing even though the mobile printing application does not support the full configurations or printing features provided by the image forming apparatus.

In accordance with an exemplary embodiment, the mobile printing application connects to the printer and synchronizes the user interfaces of the mobile printing application and the user interface of the image forming apparatus to each other. For example, in accordance with an exemplary embodiment, the user can configure the printing options to apply the printing settings to the print job by using the user interface (i.e., printer control panel) and then start the printing of the print job. When starting the printing of the print job by the user, the mobile printing application sends the print job to the image forming apparatus (or printer). After the image forming apparatus (or printer) receives the print job, the image forming apparatus (or printer) applies print options that the mobile printing application does not support (or provide) to the print job and the print job is then printed by the image forming apparatus (or printer).

In accordance with an exemplary embodiment, for example, the one or more features that are not supported by the mobile printing application can include one or more of the following: zoom, booklet print, skip blank pages, binding margin, image shifting, watermark, copy guard, two color printing, and color adjust. In accordance with an exemplary embodiment, the mobile printing application can be configured, for example, to support a limited number of features of the image forming apparatus which include one or more of the following: number of copies, two-sided printing, color mode, for example, the color mode being color or black & white (B/W), page range, paper orientation, paper size, and finishing options. In accordance with an exemplary embodiment, the finishing options can include staple, punch, and/or fold.

In accordance with an exemplary embodiment, the user sets the configurations on the mobile printing application side and sends the print job to the printer. The printer stores the print job, and the user can add and/or modify the configurations using the printer control panel. After finishing the print settings using the user interface (i.e., printer control panel) of the printer, the printer prints with selected print settings.

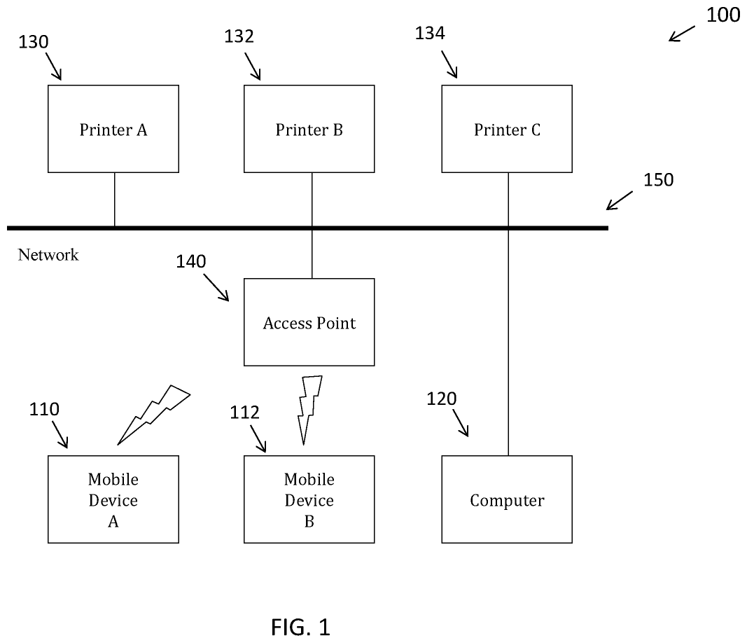

FIG. 1 is an illustration of an exemplary system 100 for printing a print job sent from a client device, for example, a mobile device 110, 112, to a printer 130, 132, 134 in accordance with an exemplary embodiment. As shown in FIG. 1, the system 100 can include one or more mobile devices 110, 112 a computing device 120, and one or more printers (or image forming apparatuses) 130, 132, 134. In accordance with an exemplary embodiment, the mobile devices 110, 112 are connected, for example, by an access point 140, for example, a WiFi router, and a communication network (or network) and/or a local area network (LAN) 150, to the one or more printers or image forming apparatuses 130, 132, 134. In accordance with an exemplary embodiment, for example, the one or more printers 130, 132, 134, can be, for example, in a print shop, an office, or a plurality of offices or buildings (not shown).

In accordance with an exemplary embodiment, the access point 140 can be any networking hardware device that allows a Wi-Fi device to connect to a wired network, or a hardware device that can allow a cellular device, for example, a smartphone to connect to the communication network 150. In accordance with an exemplary embodiment, the communication network (or network) 150 can be a public telecommunication line and/or a network (for example, LAN or WAN). Examples of the communication network 150 can include any telecommunication line and/or network consistent with embodiments of the disclosure including, but are not limited to, telecommunication or telephone lines, the Internet, an intranet, a local area network (LAN) as shown, a wide area network (WAN) and/or a wireless connection using radio frequency (RF), infrared (IR) transmission, and/or near-field communication (NFC).

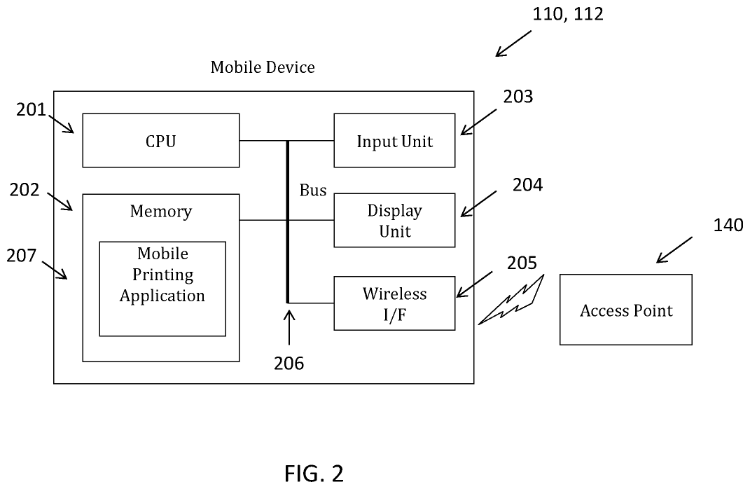

FIG. 2 is an illustration of a mobile device 110, 112 in accordance with an exemplary embodiment. As shown in FIG. 2, the mobile device 110, 112 can include a processor or central processing unit (CPU) 201, and one or more memories (i.e., non-transitory memories) 202 for storing software programs (for example, a universal printing software and one or more vendor printing software) and data (such as files to be printed). The client device includes software configured to send data for a print job to the one or more printers 130, 132, 134. The data sent from the mobile device 110, 112 to the print computer 120, or the one or more printers 130, 132, 134 may include image data (document data) and print setting data. The processor or CPU 101 carries out the instructions of a computer program, which operates and/or controls at least a portion of the functionality of the mobile device 110. The mobile device 110, 112 can also include an input unit 203, a display unit or graphical user interface (GUI) 204, and a wireless interface (I/F) 205, which is configured to be connected to an access point (or wireless network (or network) 140. A bus 206 can connect the various components 201, 202, 203, 204, 205 within the at least one mobile device 110, 112.

The mobile device 110, 112 includes an operating system (OS), which manages the computer hardware and provides common services for efficient execution of various software programs. The software programs can include, for example, printing software (i.e., a universal printing software and/or one or more vendor original printing software), which can control transmission of data for a print job from the mobile device 110, 112 to the one or more printers 130, 132, 134. In accordance with an exemplary embodiment, the mobile device 110, 112 can be a computer, a tablet, a cell phone, or a smart phone.

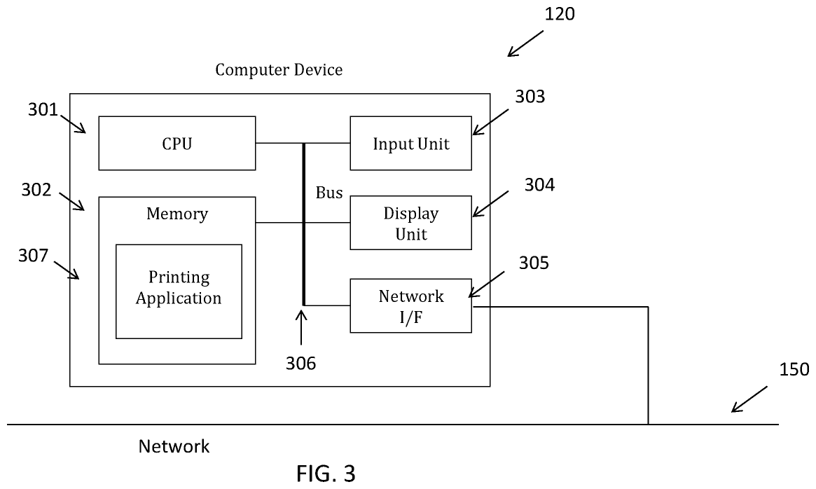

FIG. 3 is an illustration of a computer device 120 in accordance with an exemplary embodiment. As shown in FIG. 3, the computer 120 can include a processor or central processing unit (CPU) 301, and one or more memories (i.e., non-transitory memories) 302 for storing software programs and data including a job management program. The processor or CPU 301 carries out the instructions of a computer program, which operates and/or controls at least a portion of the functionality of the computer 120. The computer 120 can also include an input unit 303, a display unit or graphical user interface (GUI) 204, and a network interface (I/F) 305, which is connected to a communication network (or network) 150. A bus 306 can connect the various components 301, 302, 303, 304, 305 within the computer 120. The computer 120 includes an operating system (OS), which manages the computer hardware and provides common services for efficient execution of various software programs. The computer 120 can be computer and executes a job management program that manages a print job.

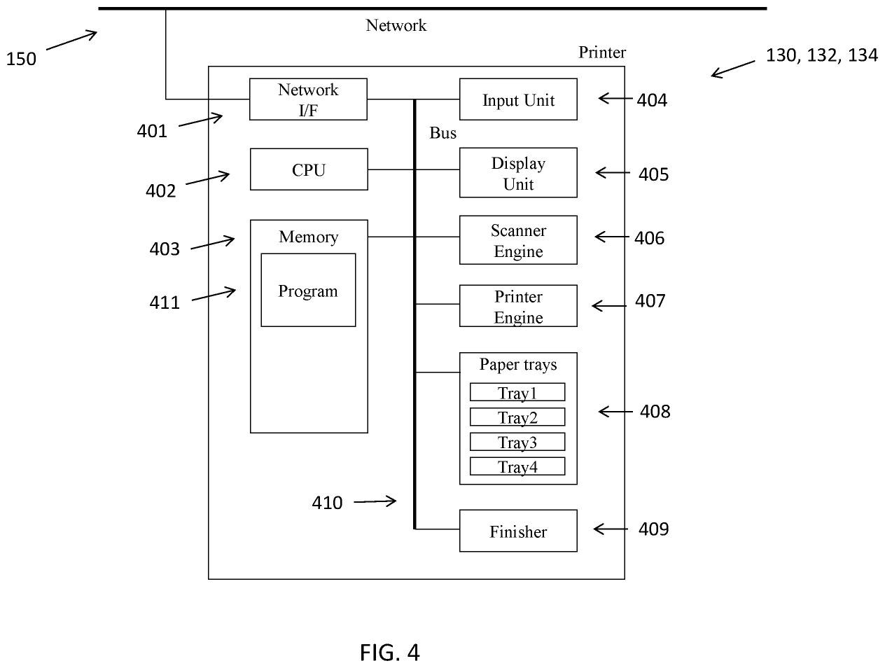

FIG. 4 is an illustration of a printer 130, 132, 134, in accordance with an exemplary embodiment. The printer 130, 132, 134, can include a network interface (I/F) 401, which is connected to the communication network (or network) 150, a processor or central processing unit (CPU) 402, and one or more memories (i.e., non-transitory memories) 403 for storing software programs 411 and data (such as files to be printed). For example, the software programs 411 can include a printer controller. The processor or CPU carries out the instructions of a computer program, which operates and/or controls at least a portion of the functionality of the printer 130, 132, 134. The printer 130, 132, 134, can also include an input unit 404, a display unit or graphical user interface (GUI) 405, a scanner engine (or scanner) 406, a printer engine 407, at least one paper tray 408, and more preferably a plurality of paper trays, 408, for example, Tray 1, Tray 2, Tray 3, Tray 4 . . . Tray N, and a finisher 409. The paper tray(s) 408 can include a bin or tray, which holds a stack of a print media, for example, a paper or a paper-like product. A bus 410 can connect the various components 401, 402, 403, 404, 405, 406, 407, 408, 409 within the printer 130, 132, 134. The printer 130, 132, 134, also includes an operating system (OS), which manages the computer hardware and provides common services for efficient execution of various software programs.

In accordance with an exemplary embodiment, it can be within the scope of the disclosure for the printer 130, 132, 134, to be a copier. The printer engine or print engine 407 has access to a print media of various sizes for a print job, which can be, for example, stored in the input tray. A “print job” or “document” can be a set of related sheets, usually one or more collated copy sets copied from a set of original print job sheets or electronic document page images, from a particular user, or otherwise related.

For example, in accordance with an exemplary embodiment, an image processing section within the printer 130, 132, 134 can carry out various image processing under the control of a print controller or CPU 402, and sends the processed print image data to the print engine 407. The image processing section can also include a scanner section (scanner 406) for optically reading a document. The scanner section receives the image from the scanner 406 and converts the image into a digital image. The print engine 407 forms an image on a print media (or recording sheet) based on the image data sent from the image processing section. The central processing unit (CPU) (or processor) 402 and the non-transitory memory 403 can include a program for RIP processing (Raster Image Processing), which is a process for converting print data included in a print job into Raster Image data to be used in the printer or print engine 407. The CPU 402 can include a printer controller configured to process the data and job information received from the computer 120, for example, received via the network connection unit and/or input/output section (I/O section) 404.

The CPU 402 can also include an operating system (OS), which acts as an intermediary between the software programs and hardware components within the printer 130, 132, 134. The operating system (OS) manages the computer hardware and provides common services for efficient execution of various software applications. In accordance with an exemplary embodiment, the printer controller can process the data and job information received from the one or more mobile devices 110, 112 to generate a print image. In accordance with an exemplary embodiment, each of the one or more printers 130, 132, 134 supports at least one vendor original printing software application.

The network I/F 401 performs data transfer with the mobile device 110, 112 and/or computer 120. The printer controller can be programmed to process data and control various other components of the multi-function peripheral to carry out the various methods described herein. In accordance with an exemplary embodiment, the operation of printer section commences when the printer section receives data for a print job from the mobile device 110, 112 and/or computer 120 via the network I/F 401. The data for the print job may include any kind of page description languages (PDLs), such as PostScript® (PS), Printer Control Language (PCL), Portable Document Format (PDF), and/or XML Paper Specification (XPS). Examples of printers 130, 132, 134, consistent with exemplary embodiments of the disclosure include, but are not limited to, a multi-function peripheral (MFP), a laser beam printer (LBP), an LED printer, and a multi-function laser beam printer including copy function.

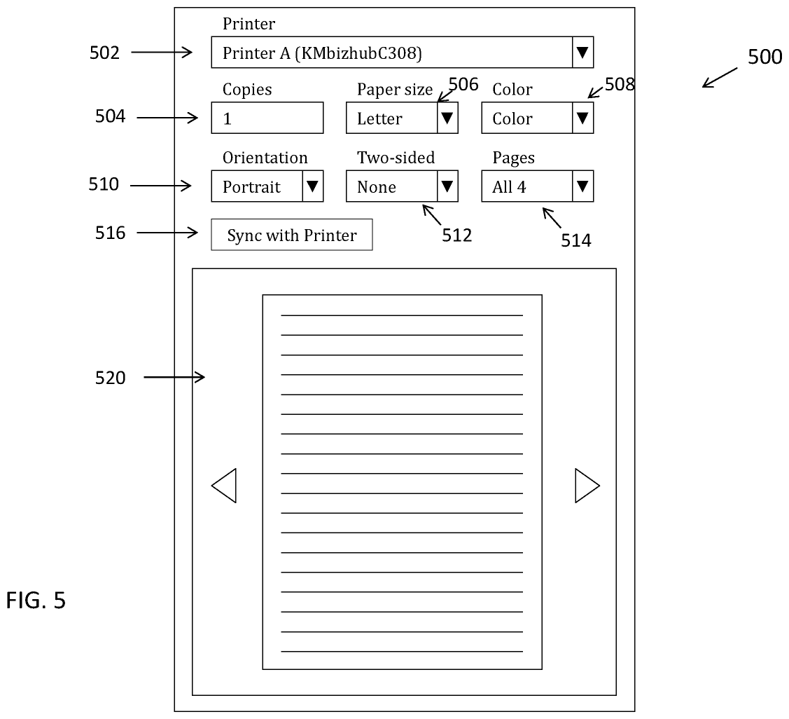

FIG. 5 is an illustration of an exemplary mobile printing application user interface 500 in accordance with an exemplary embodiment. As shown in FIG. 5, the printer driver user interface 500 (and corresponding universal printing software) enables a mobile device 110, 112 to print to a printer 130, 132, 134, without having to install a printer driver for each printer 130, 132, 134, for example, a networked printer and corresponding printing features of each printer 130, 132, 134 that are not supported by the mobile printing application 207. The printer driver user interface 500 can be compatible with any printer or multi-functional printer (MFP) that utilizes PCL6 or PostScript languages, such that a wide range of printer devices from different vendors (or manufacturers), which can be assessed on the single printer driver (i.e., universal printer driver).

As shown in FIG. 5, the mobile printing application user interface 500 can be displayed on a display unit 204 of the mobile device 110, 112, 114. The printer driver user interface 500 can include one or more tabs (or properties) corresponding to a type of printing (i.e., property), for example, basic printing and/or color printing. The printer driver user interface 500 can include a plurality of drop-down list or pull-down lists 502, 504, 506, 508, 510, 512, 514. The plurality of drop-down lists or pull-down lists, for example, can include printer name 502, the number of copies 504, paper size 506, color or black and white 508, document orientation 510 can include Landscape or Portrait, Print type 512 can include one-sided (1-sided) or two-sided (2-sided), combination 514 can include, for example, one image per page, two images per page (2 in 1), or four images per page (4 in 1). In addition, the printer driver user interface 500 can include a “Sync with Printer” 516 button and a print preview screen 520.

In accordance with an exemplary embodiment, upon selection of the “Sync with Printer” button 516, the printer driver user interface 500 of the mobile printing application 207 is synced to a printer driver user interface 405 of the printer 130,132, 134 by displaying the user interface 405 of the printer 130, 132, 134 on the mobile printing application 207. In accordance with an exemplary embodiment, a user can select the print settings for the print job on the mobile printing application 207 based on the user interface 405 of the printer 130,132, 134.

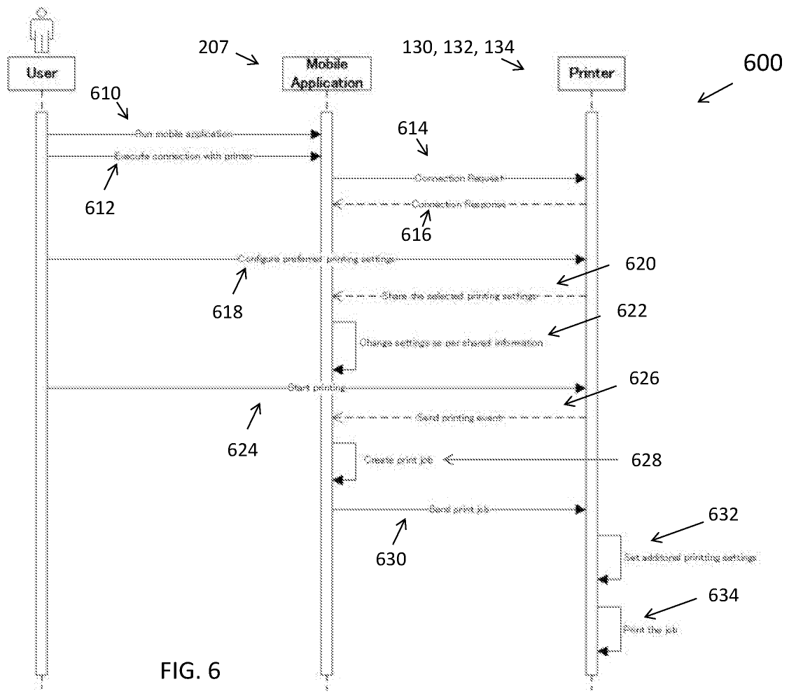

FIG. 6 is an illustration of a flow chart 600 illustrating a mobile printing application 207 of a mobile device 110, 112 in accordance with an exemplary embodiment. As shown in FIG. 6, step 610, the user runs the mobile printing application 207 on the mobile device 110. In step 612, the user selects “Sync with printer” 516 as shown in FIG. 5, which executes a connection with printer 130, 132, 134. In step 614, the mobile printing application 207 of the mobile device 110, 112 sends a connection request to the printer 130, 132, 134. In step 616, the printer 130, 132, 134 sends a connection response to the mobile printing application 207 on the mobile device 110, 112. Once the mobile printing application on the mobile device 110, 112 and the printer 130, 132, 134 are connected, the user configures preferred print settings in step 618 on the mobile printing application 207, which preferred print settings are then sent to the printer 130, 132, 134. In accordance with an exemplary embodiment, the mobile printing application 207 is configured to support a limited number of features of an image forming apparatus or printer 130, 132, 134.

In accordance with an exemplary embodiment, in step 620, after receipt of the preferred print settings, the printer 130, 132, 134, shares the selected print settings with the mobile printing application 207. In step 622, the user can change the settings as per the shared information received from the printer 130, 132, 134. Once the setting as per the shared information have been selected by the user, the users selects “start printing” on the mobile printing application 207. In step 626, the printer 130, 132, 134 receives the start printing instruction from the mobile printing application 207 and sends printing events to the mobile printing application 207. In step 628, the mobile printing application creates a print job, the print job including print data and print settings.

In step 630, the print job is sent by the mobile printing application 207 to the printer 130, 132, 134 for printing. In step 632, the printer 130, 132, 134, creates a modified print job to support the print settings in the print job that are not supported by the mobile printing application 207 by setting the additional print settings for the modified print job to be printed by the printer 130, 132, 134. In step 634, the printer 130, 132, 134 prints the modified print job on a sheet of print media from one or more trays 408 of the printer 130, 132, 134.

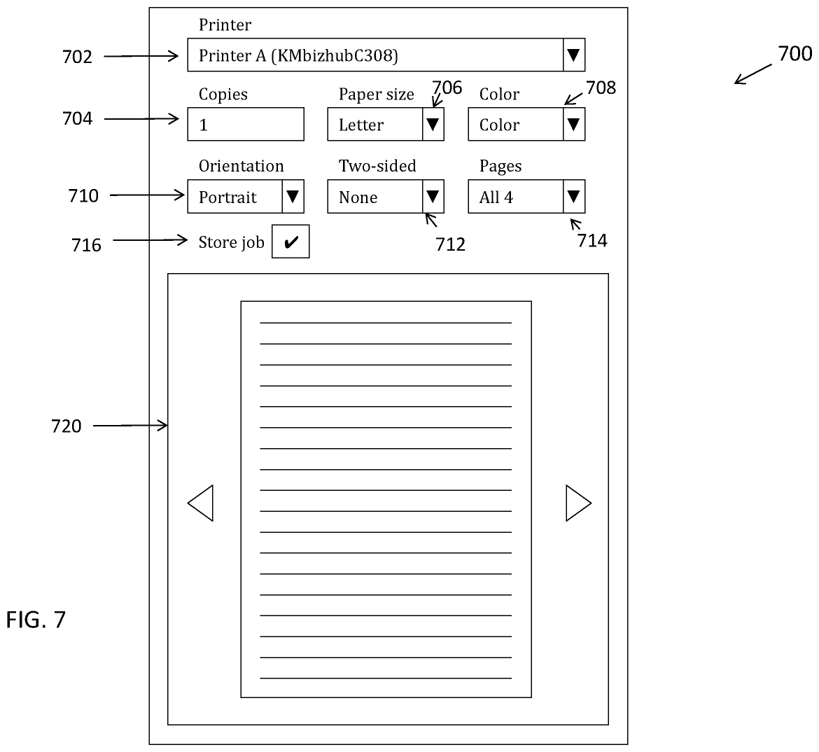

FIG. 7 is an illustration of exemplary mobile printing application user interface 700 in accordance with an exemplary embodiment. As shown in FIG. 7, the mobile printing application user interface 700 (and corresponding universal printing software) enables a mobile device 110, 112 to print to a printer 130, 132, 134, without having to install a printer driver for each printer 130, 132, 134, for example, a networked printer. The printer driver user interface 700 can be compatible with any printer or multi-functional printer (MFP) that utilizes PCL6 or PostScript languages, such that a wide range of printer devices from different vendors (or manufacturers), which can be assessed on the single printer driver (i.e., universal printer driver).

As shown in FIG. 7, the mobile printing application user interface 700 can be displayed on a display unit 204 of the mobile device 110, 112, 114. The printer driver user interface 700 can include one or more tabs (or properties) corresponding to a type of printing (i.e., property), for example, basic printing and/or color printing. The printer driver user interface 700 can include a plurality of drop-down list or pull-down lists 702, 704, 706, 708, 710, 712, 714. The plurality of drop-down lists or pull-down lists, for example, can include printer name 702, the number of copies 704, paper size 706, color or black and white 708, document orientation 710 can include Landscape or Portrait, Print type 712 can include one-sided (1-sided) or two-sided (2-sided), combination 714 can include, for example, one image per page, two images per page (2 in 1), or four images per page (4 in 1). In addition, the printer driver user interface 700 of the mobile printing application 207 can include a “Store Job” 716 button and a print preview screen 720. In accordance with an exemplary embodiment, upon selection of the “Store Job”, the print job consisting of print data and print settings can be sent to the printer 130, 132, 134, an optional printer server (not shown), or a cloud server (not shown) for printing as disclosed herein.

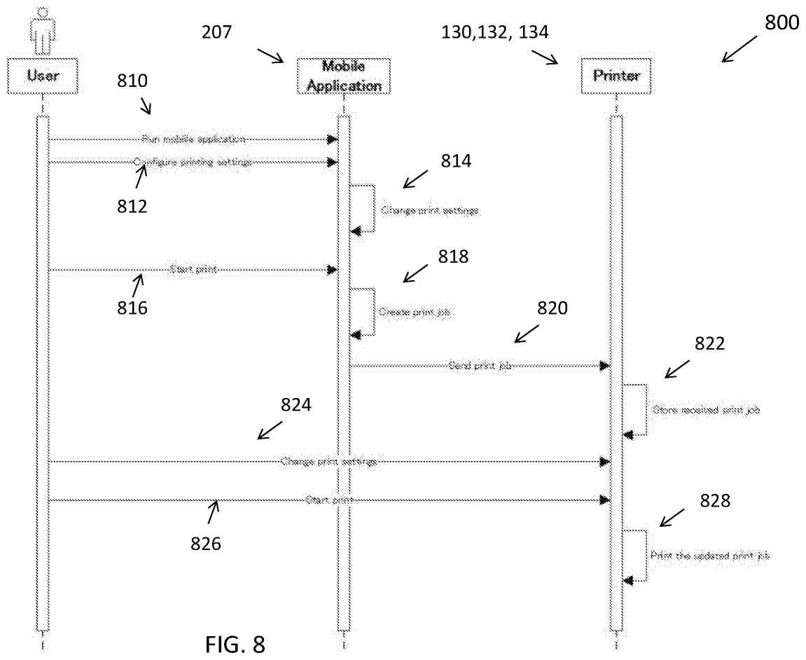

FIG. 8 is an illustration of a flow chart 800 providing a mobile printing application 207 of a mobile device 112, 112 with a full printing configuration in accordance with another exemplary embodiment. As shown in FIG. 8, step 810, the user runs the mobile printing application 207 on the mobile device 110. In step 812, the user configures the printing settings on the mobile printing application 207. In step 814, the user can change one or more of the printing settings on the mobile printing application 207, wherein the mobile printing application 207 is configured to support a limited number of features of an image forming apparatus or printer 130, 132, 134. In step 816, the user starts the print process by selecting the “Store Job” on the printer driver user interface 700 of the mobile printing application 207. In step 818, the mobile printing application 207 creates the print job, the print job consisting of print data and print settings.

In accordance with an exemplary embodiment, in step 820, the print job is sent to the printer 130, 132, 134. Upon receipt of the print job form the mobile printing application 207, the printer 130, 132, 134 stores the print job to be printed later. The storing of the print job in step 822 can be stored on the printer 130, 132, 134, stored on an optional print server (not shown), or stored on a cloud server. In step 824, the user changes the printing settings for the print job on the printer driver user interface (or display unit) 405 of the printer 130, 132, 134. In step 826, upon selection of print on the printer driver user interface (or display unit) 405, the printer 130, 132, 134 creates a modified print job with the modified print settings and in step 826, the printer 130, 132, 134, prints the print job with the modified print settings.

In accordance with an exemplary embodiment, a computer program product comprising a computer usable non-transitory medium having a computer readable program code embedded therein for displaying features of printing software on a user interface, the process comprising: storing in a non-transitory memory, a universal printing software and a vendor original printing software, the universal printing software being configured to support printers from two or more vendors, and the vendor original printing software being configured to support a printer from a vendor from the two or more vendors, and the universal printing software being configured to support a limited number of features of the printer from the vendor; displaying on the user interface of the vendor original printing software features of the printer from the vendor printer and highlighting features which are not supported by the universal printing software but supported by the vendor original printing software when a property of the vendor original printing software is selected at a time of printing on the user interface of the vendor original printing software.

The non-transitory computer readable medium may be a magnetic recording medium, a magneto-optic recording medium, or any other recording medium which will be developed in future, all of which can be considered applicable to the present invention in all the same way. Duplicates of such medium including primary and secondary duplicate products and others are considered equivalent to the above medium without doubt. Furthermore, even if an embodiment of the present invention is a combination of software and hardware, it does not deviate from the concept of the invention at all. The present invention may be implemented such that its software part has been written onto a recording medium in advance and will be read as required in operation.

It will be apparent to those skilled in the art that various modifications and variation can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A system comprising:
a mobile device, the mobile device comprising:
a processor configured to execute software stored in memory;
a non-transitory memory configured to store a mobile printing application for the mobile device, the mobile printing application configured to support a limited number of features of an image forming apparatus;
a user interface of the mobile printing application; and
wherein the mobile device is configured to send print settings to the image forming apparatus; and
the image forming apparatus comprising:
a processor configured to receive the print settings;
a non-transitory memory configured to store the print settings;
a user interface of the image forming apparatus;
wherein the image forming apparatus is configured to accept modifications to the print settings through the user interface of the image forming apparatus and to make modified print settings; and
wherein the image forming apparatus is configured to execute a print job using the modified print settings.

2. The system of claim 1, wherein a user can select whether additional configuration on the image forming apparatus is needed when the user sends the print settings.

3. The system of claim 2, wherein when the user does not select the additional configuration, the print job is automatically executed.

4. The system of claim 1, wherein the mobile device sends print data with the print settings.

5. The system of claim 1, wherein after receiving the print settings, the image forming apparatus is configured to wait for the modified print settings before executing the print job.

6. The system of claim 1, wherein the mobile printing application connects to the printer and synchronizes the user interface of the mobile printing application with the user interface of the image forming apparatus.

7. A method for configuring print jobs on a mobile device, the method comprising:
hosting a mobile printing application on the mobile device, the mobile printing application configured to support a limited number of features of an image forming apparatus;
sending a print job to the image forming apparatus for printing;
modifying the print job on the image forming apparatus to include one or more features that are not supported by the mobile printing application; and
printing the modified print job on the image forming apparatus.

8. The method of claim 7, further comprising:
connecting the mobile printing application to the image forming apparatus over a communication network;
sending preferred print settings for the mobile printing application to the image forming apparatus;
receiving the preferred print settings from the mobile printing application on the image forming apparatus;
sharing selected print settings of the image forming apparatus with mobile printing application, the shared selected print settings including the one or more features that are not supported by the mobile printing application;
changing print settings for the print job to include the one or more features that are not supported by the mobile printing application; and
sending the print job with the changed print setting to the image forming apparatus for printing.

9. The method of claim 8, further comprising:
modifying the print job to include the one or more features that are not supported by the mobile printing application on the image forming apparatus; and
printing the print job after the modifying of the print job to include the one or more features that are not supported by the mobile printing application.

10. The method of claim 8, wherein the changing of the print settings for the print job to include the one or more features that are not supported by the mobile printing application comprises:
syncing a user interface of the mobile printing application to a user interface of the image forming apparatus;
displaying the user interface of the image forming apparatus on the mobile printing application; and
selecting the print settings for the print job on the mobile printing application based on the user interface of the image forming apparatus.

11. The method of claim 8, comprising:
sending a connection request from the mobile printing application to the image forming apparatus; and
receiving a connection response form the image forming apparatus before sending the preferred printing settings to the image forming apparatus.

12. The method of claim 7, comprising:
automatically executing the print job on the image forming apparatus without modifying the print job when the print job includes only the limited number of features of the image forming apparatus supported by the mobile printing application.

13. The method of claim 7, comprising:
selecting the one or more features that are not supported by the mobile printing application on the image forming apparatus on a user interface of the image forming apparatus.

14. The method of claim 7, comprising:
receiving the print job from the mobile printing application;
storing the print job on the image forming apparatus; and
printing the print job only after input from a user on a user interface of the image forming apparatus.

15. The method of claim 7, wherein the one or more features that are not supported by the mobile printing application include one or more of the following:
zoom, booklet print, skip blank pages, binding margin, image shifting, watermark, copy guard, two color printing, and color adjust; and
wherein the mobile printing application is configured to support the limited number of features of the image forming apparatus, which include one or more of the following:
number of copies, two-sided printing, color mode, the color mode being color or black & white, page range, paper orientation, paper size, and finishing options, the finishing options including one or more of staple, punch, or fold.

16. A non-transitory computer readable medium storing computer readable program code executed by a processor for configuring print jobs on a mobile device, the process comprising:
hosting a mobile printing application on the mobile device, the mobile printing application configured to support a limited number of features of an image forming apparatus;
sending a print job to the image forming apparatus for printing;
modifying the print job on the image forming apparatus to include one or more features that are not supported by the mobile printing application; and
printing the modified print job on the image forming apparatus.

17. The non-transitory computer readable medium of claim 16, further comprising:
connecting the mobile printing application to the image forming apparatus over a communication network;
sending preferred print settings for the mobile printing application to the image forming apparatus;
receiving the preferred print settings from the mobile printing application on the image forming apparatus;
sharing selected print settings of the image forming apparatus with mobile printing application, the shared selected print settings including the one or more features that are not supported by the mobile printing application;
changing print settings for the print job to include the one or more features that are not supported by the mobile printing application; and
sending the print job with the changed print setting to the image forming apparatus for printing.

18. The non-transitory computer readable medium of claim 17, further comprising:
modifying the print job to include the one or more features that are not supported by the mobile printing application on the image forming apparatus; and
printing the print job after the modifying of the print job to include the one or more features that are not supported by the mobile printing application.

19. The non-transitory computer readable medium of claim 17, wherein the changing of the print settings for the print job to include the one or more features that are not supported by the mobile printing application comprises:
synching a user interface of the mobile printing application to a user interface of the image forming apparatus;
displaying the user interface of the image forming apparatus on the mobile printing application; and
selecting the print settings for the print job on the mobile printing application based on the user interface of the image forming apparatus.

20. The non-transitory computer readable medium of claim 16, comprising:
selecting the one or more features that are not supported by the mobile printing application on the image forming apparatus on a user interface of the image forming apparatus.
